(19) United States
(12) Patent Application Publication
(10) Pub. No.: US 2005/0082468 A1
(43) Pub. Date: Apr. 21, 2005

(54) Drilling Cutting Analyzer System and methods of applications.

(76) Inventor: Konstandinos Zamfes, Calgary (CA)

Correspondence Address: KONSTANDINOS ZAMFES, 1830 - 10TH AVE S.W., CALGARY, AB, T3C-OJ8, CA

(21) Appl. No.: 10/711,333

(22) Filed: Sep. 10, 2004

Related U.S. Application Data
(60) Provisional application No. 60/481,381, filed on Sep. 15, 2003.

(51) Int. Cl. G01V 5/00

(52) U.S. Cl. 250/254

(57) ABSTRACT

We disclose an apparatus and process for measuring the continuous flow of drilling cuttings in real time on surface while drilling. Using combination of methods and measurement apparatuses we obtaining the set of signals. The apparatus consists of the set of sensors that are placed around the analytical tube and main auger (sampling screw conveyor), obtained set of signals combination is related to the same formation with defined space-time shift. Sources of specific emissions or fields are also used. The process consists of measuring the sample to obtain specific properties related to physical and petrophysical parameters of this formation (radiation, resistivity, inductivity, density, elasticity, others). Obtained signals are passed to signal conditioning and digitizer. Using computer data processing on data and applying the parametrical dependencies and functionalities one skilled in arts can derive the desired discrimination in target properties, as rock type, porosity, density, and oil saturation.

During the drilling of the well, mud is circulating down-hole and brings up the formation cuttings of the strata penetrated at this time. After the lag time, which comprises of the annular velocity and the depth of the well, the cuttings arrive to the surface. Here at the surface the sample catcher devise patent U.S. Pat. No. 6,386,026 B1 May 14, 2002 by the author, is capturing the material and at this time the apparatus and process disclosed in this invention are measuring the physical, physic-chemical and petrophysical properties of the formation. Conventionally some of the cutting sampling is done but none of previous ways are capable to eliminate the randomness, human interference errors and homogeneity of sampling. We disclose the ways to obtain continuous sampling and measuring the properties of the drilled strata. Other analyzers are in capable or unusable for this purpose.

### BACKGROUND OF INVENTION

During the drilling of the well, mud is circulating down-hole and brings up the formation cuttings of the strata penetrated at this time. After the lag time, which comprises of the annular velocity and the depth of the well, the cuttings arrive to the surface. Here at the surface the sample catcher devise patent U.S. Pat. No. 6,386,026 B1 May 14, 2002 by the author, is capturing the material and at this time the apparatus and process disclosed in this invention are measuring the physical, physic-chemical and petrophysical properties of the formation. Conventionally some of the cutting sampling is done but none of previous ways are capable to eliminate the randomness, human interference errors and homogeneity of sampling. We disclose the ways to obtain continuous sampling and measuring the properties of the drilled strata. Other analyzers are in capable or unusable for this purpose.

### CROSS REFERENCE TO RELATED APPLICATION

U.S. Pat. No. 6,438,189 August 2002 Vourvopoulos 376/159; U.S. Pat. No. 4,493,998 January 1985 Smith, Jr., et al. 250/251.1; U.S. Pat. No. 4,081,675 March 1978 Bartz 250/255; U.S. Pat. No. 4,286,150 August 1981 Allen 250/269.2; U.S. Pat. No. 6,386,026 May 14, 2002 Zamfes 73/152.04; U.S. Pat. No. 6,715,347 Apr. 6, 2004 Zamfes 73/152.05; U.S. Pat. No. 6,276,190 Aug. 21, 2001 Zamfes 73/19.01.

### SUMMARY OF INVENTION

Apparatus and process of this invention are provided for obtaining the specific properties of the drilled formation or any discrete formation moving continuously. The series of sensors described below are selected to perform the data measurement and collection.
1. The first sensor is the natural gamma rays receiver 12 (with sodium iodine crystal) on a side of main auger 11. Their initial signal is obtained. This signal is discriminating the natural gamma radiation of different formations.
2. The second sensor of the set is beta ray sensor 13, placed beside the gamma on the side of main auger. This sensor will produce the beta radiation signal.
3. The third sensor set consists of two sensors. First is the gamma ray 15 and beta ray 16 receivers attached together on one side and the week directional beam 26 of gamma rays source 17 on opposite side of the analyzer tube 11, will produce the dual signal synchronously reflecting the absorption radiation 21 and induced radiation 16 properties of media passing inside the tube.
4. The forth sensor of the set is the Induction coil 35, with directional ferrous insert 33 this way that the magnetic field 38 is passing through the material 37 in the analytical tube. Different formations will produce different signal 36.
5. The fifth sensor of the set consists of Sonic source 42 on one side and the two receivers 43 and 44 on the opposite side; the signals obtained will be reflecting the formations properties.
6. The sixth sensor set consists of injector of dissolvent 55, which is constantly injecting small dose of dissolvent fluid into the cuttings flow and Fluorescent brightness measurement sensor 54, which measures the amplitude and frequency of light emission produced versus time.

For further processing the information collected is passed to the CPU. In the CPU the special algorithms that allow to obtain required physical, physic-chemical and petrophysical parameters.

### BRIEF DESCRIPTION OF DRAWINGS

FIG. 1. is a schematic of main auger and the sensors placed around it.

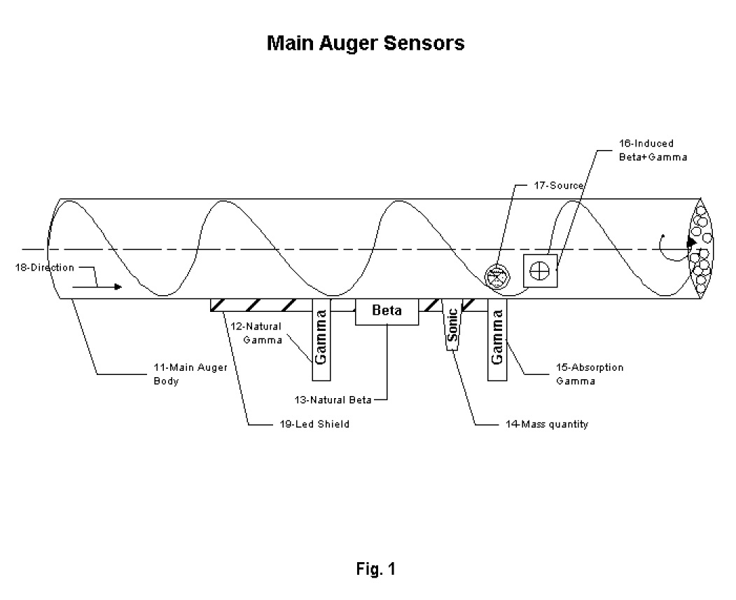

FIG. 2. is a schematic of the Absorption apparatus where the directionally restricted gamma. Beam is used as a source.

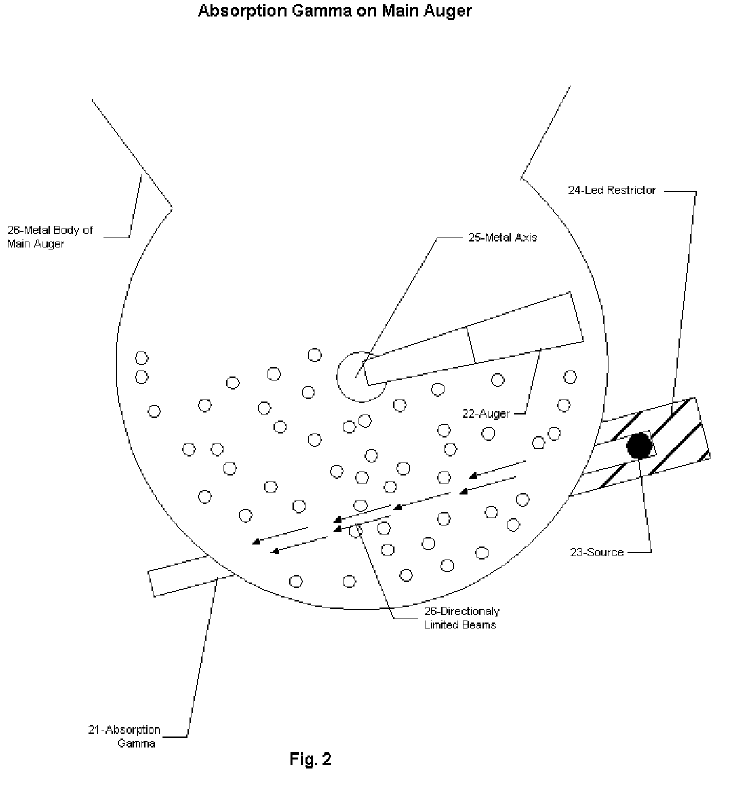

FIG. 3. is a schematic on Induction Sensor placed on Analytical auger. The body and the screws are made from plastic to eliminate the induction currents.

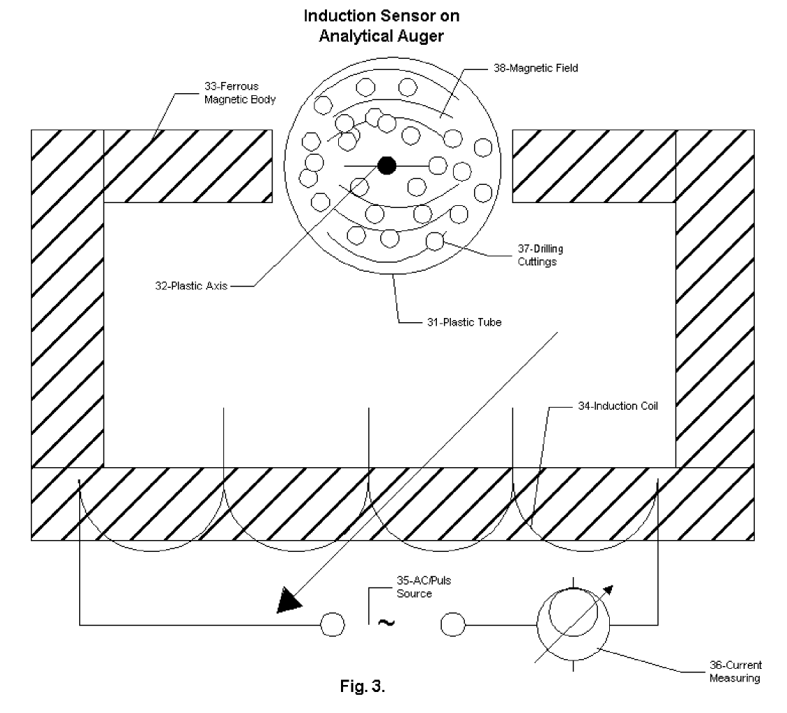

FIG. 4. is a schematic of the Sonic Sensor placed on Analytical auger and consist of the 2 receivers and a source.

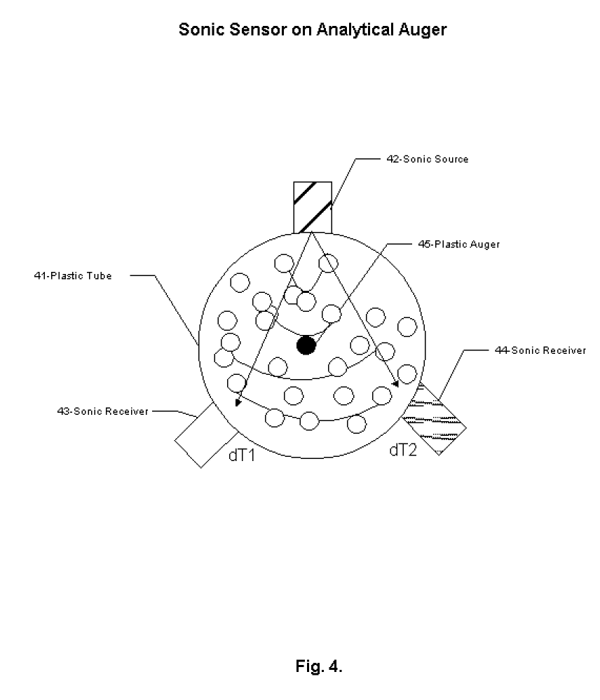

FIG. 5. is a schematic of Fluorescence Sensor in Analyzer Auger. Consist of the dissolvent injector and a fluorescent light emission sensor, analyzing the amplitude and frequency of the light emission.

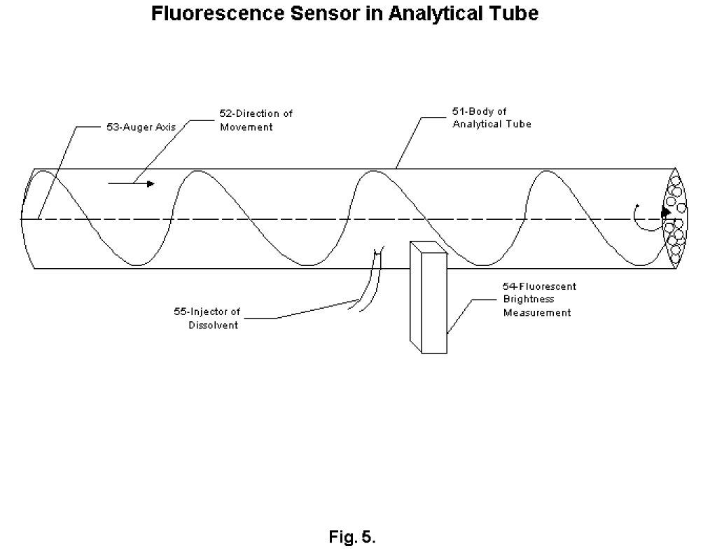

FIG. 6. is a schematic of Directional restriction of Gamma source in to the beam of gamma rays.

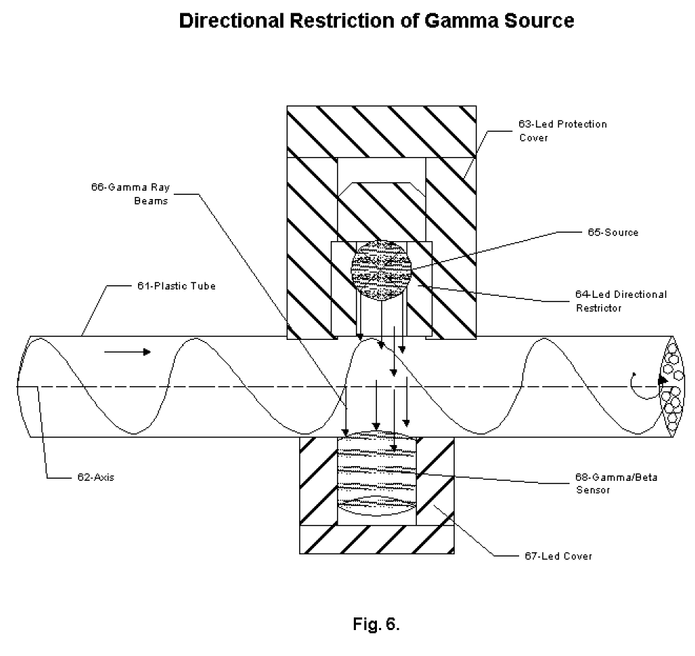

### DETAILED DESCRIPTION

The apparatus consists of the sensors described below:

1. First sensor is the natural gamma rays receiver 1 2 (with sodium iodine crystal) on a side of main auger 11 the initial signal is obtained. This signal is discriminating the natural gamma radiation of different formations. 2. Second sensor of the set is beta ray sensor 1 3, placed beside the gamma on the side of main auger. This sensor will produce the beta radiation signal measurement.

3. Third sensor set consists of two sensors. First is the gamma ray 15 and beta ray 16 receivers attached together on one side and the weak directional beams 26 of gamma rays source 17 on opposite side of the analyzer tube 11, This set will produce the dual signal synchronously reflecting the absorption radiation 21 and induced radiation 16 properties of media passing inside the tube.

4. Forth sensor of the set is the Induction coil 35, with directional ferrous insert 33. This way that the magnetic field 38 is passing through the material 37 in the analytical tube. Different formations will produce different signal 36.

5. Fifth sensor of the set consist of Sonic source 42 on one side and the 2 receivers 43 and 44 on opposite side, the signals obtained will be reflecting the formations properties.

6. Sixth sensor set is consist of injector of dissolvent 55, which is constantly injecting small dose of dissolvent in to the cuttings flow and Fluorescence brightness measurement sensor 54, which measures the amplitude and frequency of light emission produced.

THE PROCCESS consists of combination of processes to obtain specific measurement from combination of sensors described above in 1-6. This combination of measurements data related to the same material sample is further processed to solve the required problem or obtain the basic physical and petrophysical properties. The process consists of:

7. First Process (Natural Gamma) consists of obtaining the natural gamma radiation properties of substrata formations through measuring the drilling cuttings flow by means of gamma rays receiver 1 2. Shielded by led shield 1 9 from external radiation background the sensor is measuring the radiation of specific formation. These properties are factor of composition of the formation and this information is used for further processing.

8. Second Process (Natural Beta) consists of obtaining the natural gamma radiation properties of substrata formations through measuring the drilling cuttings flow by means of beta rays receiver 1 3. The shielded by led shield 1 9 from external radiation background the sensor is measuring the radiation of specific formation. These properties are factor of composition of the formation and this information is used for further oil and gas industry.

9. Third Process (Sonic) consists of obtaining the travel time from source 42 to sensors 43 and 44 and then differential signal of the two measurements is obtained. This parameters will be used in:

9.1. Characterization of substrata formations through measuring the drilling cuttings flow. The parameters related to Density, Grain size, Porosity and other can be related.

9.2. The parameter to correlate the quantity of sample passing at this time through the auger. The related deflections depending on quantity will be explained.

10. Forth Process (Absorption Gamma) consists in obtaining the measurement of gamma radiation emitted by the source 1 7 or 24 passed through the formation and received on gamma sensor 15. This measurement reflects the properties of substrata formations through measuring the drilling cuttings flow by means of Absorption of Gamma rays. The shielded by led shield 19 from external radiation background the sensor is measuring the radiation of specific formation. These properties are factor of composition of the formation and this information is used for further processing.

11. Fifth Process (Induced Gamma-Beta) consists in obtaining the measurement of gamma-beta radiation induced by the source 1 7 or 24 and measured by sensor 1 6. This measurement reflects the properties of substrata formations through measuring the drilling cuttings flow by means of induced radiation of Gamma-Beta rays. The shielded by led shield 1 9 from external radiation background the sensor is measuring the radiation of specific formation. The properties are the factor of composition of the formation and this information is used for further processing.

12. Sixth Process (Inductivity) consists in calculation of Inductivity by measuring flow current 36 produced by source 35 through coil 34. The magnetic field 38 created between Ferrous magnetic embodiments 33 is passing through the drilling cuttings 37 in plastic tube 31. This measurement reflects the electrical resistivity properties of substrata formations through measuring the drilling cuttings flow. The properties are factor of composition of the formation and this information is used for further processing.

13. Seventh Process (Fluorescent Brightness) consists in obtaining the measurement of Fluorescence brightness amplitude and frequency and builds the histogram of two parameters Amplitude versus Time. The process consists of injecting of dissolvent fluid 55, in small dose, continuously, in the formation. If the formation contained hydrocarbons Fluorescence light emission will be generated. Fluorescence brightness measurement sensor 54, which measures the amplitude and frequency of light emission produced. Time factor in measurements can be obtained in similar process disclosed by author in U.S. Pat. No. 6,71 5,347 dated Apr. 6, 2004. The measurement reflects the hydrocarbon type, presence and saturating properties of substrata formations through measuring the drilling cuttings flow. The properties are the factor of composition of the formation and this information is used for further processing.

14. Eighth Process (Algorithm for calculation of basic Formation properties) consists of:

14.1. Creating the database for real time measurements.

14.2. Analyze the physical properties that related to the same point of measurement.

14.3. Analyze the uninfluenced measurements, as self Gamma Radiation, Induction.

14.4. Analyze the influenced measurements, as induced by source Gamma Radiation Absorption and Emission, Induction of Fluorescence by injecting dissolvent fluid.

14.5. Analyze the information on known formation with calibrated properties.

14.6. Combine the pos-drilling open hole logging information for deriving the relative calculations for measurements obtained at the surface.

1. is an apparatus for measuring the natural gamma radiation in discrete media of drilling cuttings consists of:

1.1. (canceled).

1.2. is the means of obtaining signal that is discriminating the natural gamma radiation of different formations obtained at the surface from unconsolidated material and drilling cuttings.

1.3. (canceled).

1.4. (canceled).

1.5. (canceled).

1.6. (canceled).

1.7. (canceled).

2. is the apparatus for measuring the absorption properties of gamma radiation in discrete media of drilling cuttings consist of:

2.1. two sensors. First is the gamma ray 15 and beta ray 16 receivers attached together on one side.

2.2. (canceled).

2.3. (canceled).

2.4. (canceled).

3. is the apparatus for measuring the Induction Resistivity properties of formation in discrete media of drilling cuttings.

3.1. (canceled).

3.2. (canceled).

3.3. (canceled).

4. is the apparatus for measuring the Sonic velocities and penetration properties of formation in discrete media of drilling cuttings.

4.1. (canceled).

4.2. (canceled).

4.3. (canceled).

5. (canceled).

6. is the parameter to correlate the quantity of sample passing at this time through the auger. The relative deflections depending on quantity will be explained.

7. is the apparatus for Fluorescence brightness measurement by injection of dissolvent 55.

7.1. is the process of constantly injecting small dose of dissolvent in to the cuttings flow.

7.2. (canceled).

7.3. is sensor 54, which measures the amplitude and frequency of light emission produced.

7.4. (canceled).

7.5. (canceled).
